(19) United States
(12) Patent Application Publication
(10) Pub. No.: US 2015/0334437 A1
(43) Pub. Date: Nov. 19, 2015

(54) SYSTEM AND METHOD FOR UPLOADING 3D VIDEO TO VIDEO WEBSITE BY USER

(71) Applicant: 1VERGE NETWORK TECHNOLOGY (BEIJING) CO., LTD., Beijing (CN)

(72) Inventors: Haoyu Wu, Beijing (CN); Yuehuan Wang, Beijing (CN); Rui Guo, Beijing (CN); Shaoyu Wang, Beijing (CN); Ruishu Liu, Beijing (CN); Jian Yao, Beijing (CN); Dan Qiu, Beijing (CN); Hongyu Que, Beijing (CN); Boyu Pan, Beijing (CN); Shuqi Lu, Beijing (CN)

(73) Assignee: 1VERGE NETWORK TECHNOLOGY (BEIJING) CO., LTD., Beijing (CN)

(21) Appl. No.: 14/412,453

(22) PCT Filed: Jul. 11, 2013
(86) PCT No.: PCT/CN2013/079244

§ 371 Date: Jan. 1, 2015

(30) Foreign Application Priority Data
Jul. 4, 2012 (CN) 201210229973.3

(51) Int. Cl. H04N 21/2743; H04N 21/81; H04N 21/266; H04N 13/00; H04N 21/2343

(52) U.S. Cl. CPC H04N 21/2743; H04N 13/0059; H04N 21/234309; H04N 21/26603; H04N 21/816

(57) ABSTRACT

A system for uploading a 3D video to a video website by a user is characterized by comprising the following modules: a user uploading platform (1) configured to upload a video and to perform classification and identification on the video; a website video processing background (2) configured to perform operations of content censoring, 3D censoring and 3D video transcoding on the video in the background; an intermediate layer (3) configured to add a 3D attribute label to a 3D video; a website frontend (4) configured to return video meta information and to provide 3D video related information for a website user and a frontend player; and a frontend player (5) configured to perform 3D video playback processing according to the attribute label of the video identified as 3D, and to form a 3D video on the website eventually for being viewed by the user.

### CROSS-REFERENCE TO RELATED APPLICATION

This is a national stage application of the international application, application number PCT/CN2013/079244, filed on Jul. 11, 2013, which claims the priority of a Chinese application number 201210229973.3, filed on Jul. 4, 2012, which is incorporated by reference in its entirety.

### FIELD OF THE INVENTION

The present invention pertains to the field of three dimensional video processing technologies, and in particular, relates to a system and method for uploading a 3D video to a video website by a user.

### BACKGROUND

In recent years, with gradual rise of three dimensional video, the three dimensional (3D) effect display technology has become one of the present hot technologies. The 3D effect realized in a video is one in which by making use of the principle of binocular stereo vision and letting the images viewed by two eyes be different, a user obtains a visual effect of three dimensional spatial images, thereby producing an immersive feeling. Presently, relatively mature 3D techniques comprise the following three kinds:

1. anaglyphic 3D technique (i.e., Anaglyphic3D), which means that images taken from different perspectives by two cameras are printed in two different colors in the same picture, respectively. In the Anaglyphic3D, spectral information is first separated by a rotary filter wheel, and optical filters of different colors are used to filter a picture, such that one picture may generate two images, and each eye of a person sees a different image. Such a method easily causes edges of a picture to produce a color cast, and needs to be equipped with most common red-blue 3D glasses.

2. polarized 3D technique (i.e., Polarization3D), which means that an original image is decomposed utilizing the principle of a light ray having a “vibration direction”. An image is first decomposed into two groups of pictures of vertically polarized light and horizontally polarized light, then a pair of 3D glasses employs polarized lenses of different polarization directions for the left and right sides respectively, and thus the left and right eyes of a person may receive two groups of pictures which are then synthesized by the brain into a stereo image, wherein what is used cooperatively is a pair of passive polarized glasses.

3. active shutter 3D technique (i.e., ActiveShutter3D), which is implemented according to the sensitivity of capturing image frequency by two eyes of a person, rapidly refreshed images of 60 Hz are outputted to the left eye and the right eye respectively by increasing a screen refresh rate (at least 120 Hz), and thus a stereo visual perception will be realized in the brain of a person, wherein what is used cooperatively is a pair of active shutter 3D glasses.

Nowadays, three dimensional video display technologies are comparatively widely applied in such a traditional device as a TV set, etc., whereas for video websites, some existing 3D video websites only realize simple 3D technologies, and provide a user with the 3D effect of an anaglyphic 3D video, of which viewing experience is not very satisfactory. Furthermore, video websites which have a user uploading channel also only support a user to upload a pre-processed anaglyphic 3D video, the user may not upload independent two-way upper-and-lower styled 3D video and left-and-right styled 3D video, and it is very difficult to meet the heavy demand of users for 3D videos.

### SUMMARY

In view of the drawbacks of the prior art, aspects of present invention provide a system for uploading a 3D video to a video website by a user characterized by comprising one or more of the following modules:

a user uploading platform (1) configured to upload a video and to perform classification and identification on the video;

a website video processing background (2) configured to perform operations of content censoring, 3D censoring and 3D video transcoding on the video in the background;

an intermediate layer (3) configured to add a 3D attribute label to a 3D video;

a website frontend (4) configured to return video meta information and to provide 3D video related information for a website user and a frontend player; and

a frontend player (5) configured to perform 3D video playback processing according to the attribute label of the video identified as 3D, and to form a 3D video on the website eventually for being viewed by the user.

Further, the system according to one embodiment of the invention for uploading a 3D video to a video website by a user of the invention is characterized in that there are two kinds of 3D playback formats of the video, the upper-and-lower style and the left-and-right style.

Further, the system according to one embodiment of the invention for uploading a 3D video to a video website by a user of the invention is characterized in that the 3D video transcoding refers to converting a compression-coded video code stream into another video code stream to be adapted to a different network bandwidth, a different terminal processing power and a different user demand, particularly comprising increasing the code rate, adding a 3D logo, and adding a 3D subtitle.

Further, the system according to one embodiment of the invention for uploading a 3D video to a video website by a user of the invention is characterized in that when adding a 3D attribute label, the intermediate layer adds a label “H” to a left-and-right styled 3D video, and adds a label “V” to an upper-and-lower styled 3D video.

In addition, embodiments of invention further provide a method for uploading a 3D video to a video website by a user characterized by comprising one or more of the following steps:

S1, uploading a video and performing classification and identification on the video by a user uploading platform;

S2, a website video processing background performing operations of content censoring, 3D censoring and 3D video transcoding on the video in the background;

S3, adding a 3D attribute label to a 3D video;

S4, a website frontend returning video meta information and providing 3D video related information for a website user and a frontend player when the user requests a video; and

the frontend player performing 3D video playback processing according to the attribute label of the video identified as 3D, and forming a 3D video on the website eventually for being viewed by the user.

Further, the method according to one embodiment of the invention for uploading a 3D video to a video website by a user of the invention is characterized in that there are two kinds of 3D playback formats of the video, the upper-and-lower style and the left-and-right style.

Further, the method according to one embodiment of the invention for uploading a 3D video to a video website by a user of the invention is characterized in that the 3D video transcoding refers to converting a compression-coded video code stream into another video code stream to be adapted to a different network bandwidth, a different terminal processing power and a different user demand, particularly comprising increasing the code rate, adding a 3D logo, and adding a 3D subtitle.

Further, the method according to one embodiment of the invention for uploading a 3D video to a video website by a user of the invention is characterized in that when adding a 3D attribute label, the intermediate layer adds a label “H” to a left-and-right styled 3D video, and adds a label “V” to an upper-and-lower styled 3D video.

Embodiments of the invention provide a platform for users to upload various processed 3D videos and 3D raw videos, and an extensive interaction of 3D video resources is realized. All the 3D videos in a website may have normative identifications and good quality by unified video processing in the background of 3D videos uploaded by users and 3D videos within a video library of the website. A 3D video of a good effect may be provided to the user eventually on the website by further processing of the 3D video in the frontend player.

### BRIEF DESCRIPTION OF THE DRAWINGS

FIG. 1 is a module diagram of a system for uploading a 3D video to a video website by a user according to one embodiment of the invention.

FIG. 2 is a flow chart of a method for uploading a 3D video to a video website by a user according to one embodiment of the invention.

### DETAILED DESCRIPTION

In order to make the above objects, features and advantages of the present invention clearer and more understandable, the embodiments of the present invention will be further described hereinafter in detail conjunction with the drawings and the particular embodiments.

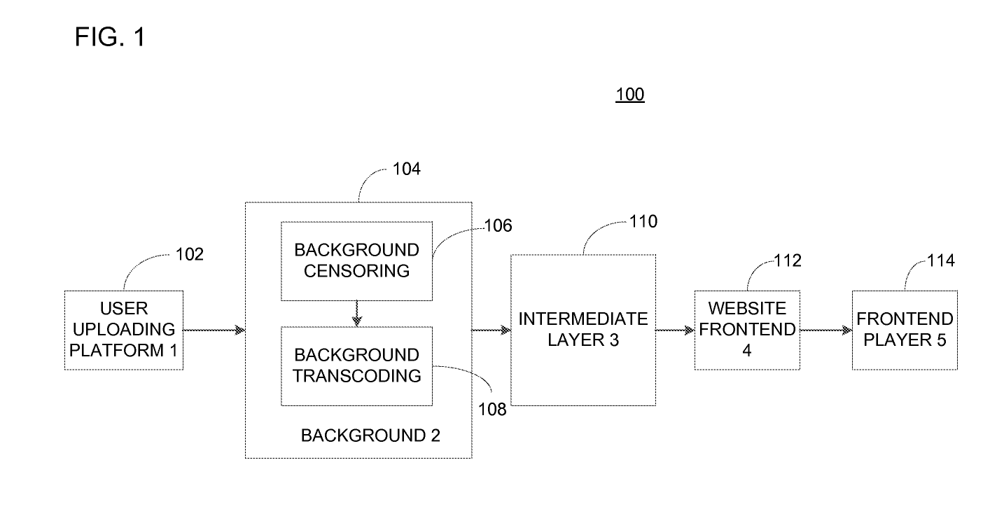

FIG. 1 is a module diagram of a system 100 for uploading a 3D video to a video website by a user of an embodiment of the present invention. As shown in FIG. 1, the system 100 for processing a 3D video in a video website of the present invention has five modules in total in one embodiment.

A user uploading platform 1 at 102 is configured to upload a video and to perform classification and identification on the video. There are two kinds of primary 3D playback formats, the upper-and-lower style and the left-and-right style. The left-and-right styled 3D video is in a playback status in which the screen is divided into two parts, the left side and the right side, both sides plays the same content simultaneously, but there are differences between them, and video interlace is generated through these differences, such that a user generates a 3D perception. The principle of the upper-and-lower styled 3D video is similar to that of the left-and-right style, also in a video format of non-standard aspect ratio, the upper-and-lower format is in an upper-and-lower arrangement, and the difference between them lies in that for the upper-and-lower format, the resolution algorithm is that when playing into a 3D effect, a frame length of a video sub-movie remains unchanged, and a width is one half of the original width, whereas for the left-and-right format, when playing into a 3D effect, a frame width of a movie remains unchanged, and the length is one half of the original length.

There are the following two classification methods.

(1) Labeling: a video label is set mainly for identifying a 3D video, wherein the 3D video format is the upper-and-lower style or the left-and-right style.

(2) Categorization: video categories are set through a checkbox. Other video categories may be classified while for a 3D video. The 3D video format is set through a radio box, a 3D video is different from a normal video, and the video format may further be subdivided into the upper-and-lower style and the left-and-right style.

At 104, a website video processing background 2 is configured to perform operations of 3D censoring at 106 and 3D video transcoding on the video in the background at 108.

The 3D video censoring in the background adopts two modes as following.

(1) Pass of the 3D Censoring By Default.

The 3D video censoring does not undergo the censoring of background management personnel, it is believed that the uploader has already performed a corresponding operation of 3D video classification or labeling on the video, the 3D censoring is passed by default, and the 3D video is directly transcoded.

(2) Censoring of a 3D Video Uploaded by a User in the Background

a. If the user has already labeled the video or set the video category, the background censoring personnel may judge the format of the 3D video according to the label or category set by the user, and confirm whether the 3D attribute of the user's video is correct or not;

b. If the user has not labeled the video or set the video category, the background censoring personnel need to first judge whether the uploaded video is a 3D video, then judge whether the format of the 3D video is the upper-and-lower style or the left-and-right style, and make unified identification for the video in the background.

The procedure of the operation of video transcoding in the background is as follows according to one embodiment of the invention.

In comparison to a normal video, supplementation of the following three aspects needs to be done in the background when implementing the 3D video transcoding.

(1) Increasing a Code Rate

The 3D video format is divided into the upper-and-lower style and the left-and-right style, and a certain resolution algorithm is adopted for videos of these two formats so as to change the size of a video to some extent. Taking an upper-and-lower styled 3D video of 480 P as an example, the frame length of a sub-video remains unchanged, the width is one half of the original width, the upper and lower sub-videos only occupy one half of 480 P, and therefore the sharpness will be affected to a certain degree when a final 3D video is synthesized. In order to obtain a relatively clear 3D video effect after transcoding, the code rate may be increased appropriately.

(2) Adding a 3D Logo

In order for a 3D video to have a unified identification when playing, a 3D logo is added after transcoding. When adding a logo, the principle of 3D video synthesization is utilized to cause the positions of the logos of the two sub-videos of an upper-and-lower styled as well as a left-and-right styled 3D video to be slightly different, and the resultant logo has a 3D effect.

(3) Adding a 3D Subtitle

If the 3D video uploaded by a user is accompanied with a subtitle, 3D processing may be performed on the subtitle, such that the subtitle appears to also have a 3D effect. The principle of adding a 3D subtitle is consistent with that of adding a 3D logo.

According to one embodiment, at 110, an intermediate layer 3 is configured to add a 3D attribute label to a 3D video. After a user uploads a 3D video, some 3D attribute labels are added to the 3D video, a label “H” is added to a left-and-right styled 3D video, a label “V” is added to an upper-and-lower styled 3D video, and a server associates the 3D video with the 3D attribute. The function of adding a 3D label is to distinguish whether the video pertains to a normal video, or a 3D video. If a 3D label is not added to a 3D video, the 3D video will be played as a normal video. Hence, adding a 3D label is an essential link.

At 112, a website frontend 4 is configured to return video meta-information and to provide 3D video related information for a website user and a frontend player, e.g., the video address, the uploading time and the 3D information, etc.

First, the player accesses a video server interface, and if a 3D label is contained in the data returned by the interface, the frontend player judges that the video is a 3D video, and performs further processing on the 3D video.

A frontend player 5 at 114 is configured to perform 3D video playback processing on the video identified as 3D, and to form a 3D video on the website eventually for being viewed by the user. The particular procedure comprises the following steps S1-S7.

S1, the player loads the original video and judges the 3D format of the original video utilizing the meta information.

S2, anaglyph processing, polarization processing or shutter processing is performed respectively according to a different 3D format.

S3, the upper video and the lower video undergoing anaglyph processing, polarization processing or shutter processing are synthesized.

S4, the left video and the right video undergoing anaglyph processing, polarization processing or shutter processing are synthesized.

S5, the video synthesized from the upper and lower sides and the video synthesized from the left and right sides are again synthesized.

S6, stretch processing is performed on the size of the synthesized video.

S7, a 3D picture is obtained after the above described processing procedures, and a dynamic 3D video is formed eventually by repeatedly redrawing subsequent pictures.

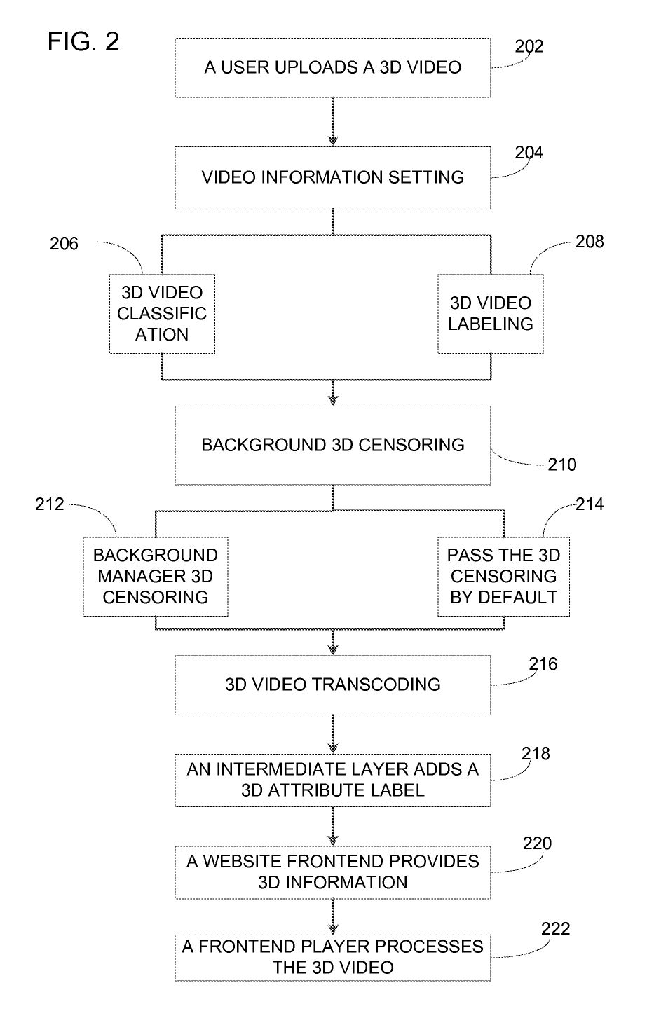

FIG. 2 is a flow chart of a method for uploading a 3D video to a video website by a user according to an embodiment of the invention. As shown in FIG. 2, the method for uploading a 3D video to a video website by a user of the invention mainly comprises the following steps.

At 202, a user uploads a 3D video, and sets video information at 204.

In one example, there are two kinds of primary 3D playback formats, the upper-and-lower style and the left-and-right style. The left-and-right styled 3D video is in a playback status in which the screen is divided into two parts, the left side and the right side, both sides plays the same content simultaneously, but there are differences between them, and video interlace is generated through these differences, such that a user generates a 3D perception. The principle of the upper-and-lower styled 3D video is similar to that of the left-and-right style, also in a video format of non-standard aspect ratio, the upper-and-lower format is in an upper-and-lower arrangement, and the difference between them lies in that for the upper-and-lower format, the resolution algorithm is that when playing into a 3D effect, a frame length of a video sub-movie remains unchanged, and a width is one half of the original width, whereas for the left-and-right format, when playing into a 3D effect, a frame width of the movie remains unchanged, and the length is one half of the original length.

There are the following two classification methods.

(1) Labeling: a video label at 208 is set mainly for identifying a 3D video, wherein the 3D video format is the upper-and-lower style or the left-and-right style.

(2) Categorization: video categories at 206 are set through a checkbox. Other video categories may be classified while for a 3D video. The 3D video format is set through a radio box, a 3D video is different from a normal video, and the video format may further be subdivided into the upper-and-lower style and the left-and-right style.

The video is associated with the set 3D video information by a server, in one example.

In another example, at 210, 3D censoring in the background is performed. In one example, the background censors a 3D video at 212 uploaded by the user, the content of which is as follows.

The 3D video censoring in the background adopts two modes as following.

(1) Pass of the 3D Censoring by Default at 214

The 3D video censoring does not undergo the censoring of background management personnel, it is believed that the uploader has already performed a corresponding operation of 3D video classification or labeling on the video, the 3D censoring is passed by default, and the 3D video is directly transcoded.

(2) Censoring of the 3D Video Uploaded by the User in the Background at 212

a. If the user has already labeled the video or set the video category, the background censoring personnel may judge the format of the 3D video according to the label or category set by the user, and confirm whether the 3D attribute of the user's video is correct or not;

b. If the user has not labeled the video or set the video category, the background censoring personnel need to first judge whether the uploaded video is a 3D video, then judge whether the format of the 3D video is the upper-and-lower style or the left-and-right style, and make unified identification for the video in the background.

Still referring to FIG. 2, at 216, 3D video transcoding is processed in the background.

In this example, the video transcoding refers to converting a compression-coded video code stream into another video code stream to be adapted to a different network bandwidth, a different terminal processing power and a different user demand. In comparison to a normal video, supplementation of the following three aspects needs to be done in the background when implementing the 3D video transcoding.

(1) Increasing the Code Rate

The 3D video format is divided into the upper-and-lower style and the left-and-right style, and a certain resolution algorithm is adopted for videos of these two formats so as to change the size of a video to some extent. Taking an upper-and-lower styled 3D video of 480 P as an example, the frame length of a sub-video remains unchanged, the width is one half of the original width, the upper and lower sub-videos only occupy one half of 480 P, and therefore the sharpness will be affected to a certain degree when a final 3D video is synthesized. In order to obtain a relatively clear 3D video effect after transcoding, the code rate may be increased appropriately.

(2) Adding a 3D Logo

In order for a 3D video to have a unified identification when playing, a 3D logo is added after transcoding. When adding a logo, the principle of 3D video synthesization is utilized to cause the positions of the logos of the two sub-videos of an upper-and-lower styled as well as a left-and-right styled 3D video to be slightly different, and the resultant logo has a 3D effect.

(3) Adding a 3D Subtitle

If the 3D video uploaded by the user is accompanied with a subtitle, 3D processing may be performed on the subtitle, such that the subtitle appears to also have a 3D effect. The principle of adding a 3D subtitle is consistent with that of adding a 3D logo.

4. Adding a 3D Attribute Label in the Intermediate Layer

After a user uploads a 3D video, some 3D attribute labels at 218 may be added to the 3D video, a label “H” is added to a left-and-right styled 3D video, a label “V” is added to an upper-and-lower styled 3D video. A frontend player accesses a video server interface, and a 3D label is contained in the returned data, such that the frontend player may judge which videos are 3D videos according to these 3D attributes, and perform further processing on the video identified as 3D.

5. Processing of the Frontend Player at 222

The frontend player processes a 3D video. For an upper-and-lower styled or left-and-right styled 3D video uploaded by the user, judgment of 3D formats is performed respectively by dividing out the upper side and lower side, the left side and right side, and then the videos of the upper side and lower side as well as the videos of the left side and right side are synthesized into a 3D video. In particular, the size of the synthesized video is first set, corresponding picture level processing is performed on the upper and lower videos respectively according to the selected processing method, and then the two processed pictures are superimposed together and rendered into a 3D picture. Since the size of the video may change during the processing, size stretching is performed on the video after the processing, and a final 3D video is formed.

In a further example, other embodiments are described as following.

1. After a user uploads a 3D video, 3D censoring is performed in the background after content censoring. If the user has not classified the video when uploading, nor labeled the video, and directly uploaded the video, since the background does not find the category or label of the video when performing 3D censoring, it is necessary to first judge kind of the video. The video is determined to be a 3D video through judgment, it is further judged that the video is a left-and-right styled 3D video, and the video transcoding is performed after unified labeling of the video.

2. After a user uploads a 3D video, 3D censoring is performed in the background after basic censoring. If the user has performed 3D video classification on the video when uploading, and selected the 3D format of the left-and-right style, the background finds the classification of the video is a left-and-right styled 3D video when performing 3D censoring, and directly performs video transcoding after unified labeling of the video.

3. For a 3D video within a video library of a website, the step of uploading by a system user may be skipped, after censoring in the background, a 3D video label is directly made to the video and the video transcoding is performed, and the video is transferred by the intermediate layer to the frontend player for processing.

The present invention provides a platform for a user to upload various processed 3D videos and 3D raw videos, and an extensive interaction of 3D video resources is realized. All the 3D videos in a website at 220 will have normative identifications and good quality by unified video processing in the background of 3D videos uploaded by users and 3D videos within a video library of the website. A 3D video of a good effect will be provided to the user eventually on the website by further processing of the 3D video in the frontend player.

In the end, it should be noted that the above embodiments are used for illustrating rather than limiting the technical solutions of the invention. While the invention has been described in detail with reference to preferred embodiments, it will be understood by those of ordinary skills in the art that the particular embodiments of the invention may still be modified or the partial technical features thereof may be replaced equivalently without departing the spirit of the technical solutions of the invention, which should all be encompassed within the scope of the claimed technical solutions of the invention.

What is claimed is:

1. A system for uploading a 3D video to a video website by a user, comprising the following modules:
a user uploading platform (1) configured to upload a video and to perform classification and identification on the video;
a website video processing background (2) configured to perform operations of content censoring, 3D censoring and 3D video transcoding on the video in the background;
an intermediate layer (3) configured to add a 3D attribute label to a 3D video;
a website frontend (4) configured to return video meta information and to provide 3D video related information for a website user and a frontend player; and
a frontend player (5) configured to perform 3D video playback processing according to the attribute label of the video identified as 3D, and to form a 3D video on the website eventually for being viewed by the user.

2. The system for uploading a 3D video to a video website by a user according to claim 1, wherein there are two kinds of playback formats of the 3D video, the upper-and-lower style and the left-and-right style.

3. The system for uploading a 3D video to a video website by a user according to claim 1, wherein the 3D video transcoding refers to converting a compression-coded video code stream into another video code stream to be adapted to a different network bandwidth, a different terminal processing power and a different user demand, particularly comprising increasing the code rate, adding a 3D logo, and adding a 3D subtitle.

4. The system for uploading a 3D video to a video website by a user according to claim 1, wherein when adding a 3D attribute label, the intermediate layer (3) adds a label “H” to a left-and-right styled 3D video, and adds a label “V” to an upper-and-lower styled 3D video.

5. A method for uploading a 3D video to a video website by a user, comprising the following steps:
S1, uploading a video and performing classification and identification on the video by a user uploading platform;
S2, a website video processing background performing operations of content censoring, 3D censoring and 3D video transcoding on the video in the background;
S3, adding a 3D attribute label to a 3D video;
S4, a website frontend returning video meta information and providing 3D video related information for a website user and a frontend player when the user requests a video; and
the frontend player performing 3D video playback processing according to the attribute label of the video identified as 3D, and forming a 3D video on the website eventually for being viewed by the user.

6. The method for uploading a 3D video to a video website by a user according to claim 5, wherein there are two kinds of 3D playback formats of the video, the upper-and-lower style and the left-and-right style.

7. The method for uploading a 3D video to a video website by a user according to claim 5, wherein the 3D video transcoding refers to converting a compression-coded video code stream into another video code stream to be adapted to a different network bandwidth, a different terminal processing power and a different user demand, particularly comprising increasing the code rate, adding a 3D logo, and adding a 3D subtitle.

8. The method for uploading a 3D video to a video website by a user according to claim 5, wherein when adding a 3D attribute label, the intermediate layer adds a label “H” to a left-and-right styled 3D video, and adds a label “V” to an upper-and-lower styled 3D video.
